(19) United States
(12) Patent Application Publication
(10) Pub. No.: US 2007/0206885 A1
(43) Pub. Date: Sep. 6, 2007

(54) Imaging System And Image Processing Program

(76) Inventor: Chenggang Wen, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/578,468

(22) PCT Filed: Apr. 13, 2005
(86) PCT No.: PCT/JP05/07489

§ 371 Date: Oct. 13, 2006

(30) Foreign Application Priority Data
Apr. 14, 2004 (JP) 2004-119051

(51) Int. Cl. G06K 7/00

(52) U.S. Cl. 382/312

(57) ABSTRACT

Acquired video signals are forwarded to pre-processing block (103) for sampling, gain amplification and A/D conversion, and then forwarded to image buffer (104). Video signals in image buffer (104) are forwarded to noise estimation block (106). On the basis of taking conditions, video signals and a reference noise model, noise estimation block (106) works out the quantity of noise per ISO sensitivity, and per color signal. The calculated noise quantity is forwarded to noise reduction block (105). On the basis of the noise quantity estimated at the noise estimation block (106), the noise reduction block (105) applies noise reduction processing to video signals in image buffer (104), and video signals after noise reduction processing are forwarded to signal processing block (108).

### TECHNICAL ART

The present invention relates to an imaging system and an image processing program, wherein the quantity of random noise ascribable to an imaging device is estimated on the basis of dynamically changing factors such as signal value levels, ISO sensitivities and color signals, thereby achieving high-precision reduction of noise components only.

### BACKGROUND ART

Noise components included in digitalized signals obtained from an imaging device, its associated analog circuit and an A/D converter are generally broken down into fixed pattern noise and random noise. As represented by defective pixels or the like, the fixed pattern noise results chiefly from an imaging device. On the other hand, the random noise occurs at the imaging device and analog circuit, having characteristics close to white noise ones.

Regarding the random noise, for instance, JP-A 2001-157057 shows a technique wherein the quantity of noise is turned into a function with respect to a signal level, the quantity of noise with respect to a signal level is estimated from that function, and the frequency characteristics of filtering are controlled on the basis of that quantity of noise. This will apply adaptive noise reduction processing to the signal level.

In JP-A 2001-157057, the function N=ab^{cD} is given with N as the noise quantity and D as a signal level converted into a density value. Here, a, b and c are each a statically given constant term. However, the noise quantity changes dynamically with temperatures at a taking time, exposure times, gains, etc. In other words, the precision of noise quantity estimation is poor, because of inability to be adaptive to that function fit for the noise quantity at the taking time.

In view of such problems with the prior art, it is one object of the present invention to provide an imaging system, and an image processing program, which uses a noise quantity model well adaptive to not only signal levels but also dynamically changing factors such as signal value levels in association with random noise, ISO sensitivities and color signals to make a precise noise quantity estimation. For that precise noise quantity estimation, there are high-precision parts required to acquire elements like signal value levels, ISO sensitivities and color signals, which result in some costs added to a hardware system. It is thus another object of the present invention to provide an imaging system, and an image processing program, which relies upon simplified noise model processing, thereby lessening loads on hardware while the desired noise quantity estimation precision is maintained.

### DISCLOSURE OF THE INVENTION

(1) To accomplish the aforesaid objects, the present invention provides an imaging system adapted to process a digitalized signal from an imaging device, characterized by comprising a noise estimation means for estimating a quantity of noise in said signal and an image processing means for implementing image processing based on said quantity of noise. The invention of (1) is embodied as the first, the second, and the third embodiment shown in FIGS. 1-16. The noise estimation means is equivalent to the noise estimation block 106 shown in FIGS. 1 and 2, the noise estimation block 1006 shown in FIGS. 3 and 4, and the noise estimation block 5006 shown in FIGS. 5 and 6. The image processing means is equivalent to the noise reduction block 105 shown in FIGS. 1 and 2, and the noise reduction block 1005 shown in FIGS. 3-6. In a preferable embodiment of the imaging system according to the invention of (1), the quantity of noise is estimated by the noise estimation block 106 in the first embodiment of FIG. 1, the noise estimation block 1006 in the second embodiment of FIG. 3, and the noise estimation block 5006 in the third embodiment of FIG. 5, and image processing is implemented on the basis of the estimated noise quantity. With the invention of (1), the quantity of noise is precisely estimated, and image processing is implemented on the basis of it. The precise estimation of noise quantity ensures image processing capable of generating high-definition images.

(2) In the invention of (1), said noise estimation means is characterized by comprising a calculation means for working out the quantity of noise per ISO sensitivity, and per color signal, based on at least one or more reference noise models and correction coefficients accommodating to a color imaging device. The invention of (2) is embodied as the first embodiment shown in FIGS. 1, 2, 5, 7, 10, and 12-14. The calculation means corresponding to the color imaging device is equivalent to the block signal extraction block 200, the color signal separation block 201, the average calculation block 202, the interval retrieval block 203, the noise interpolation block 204, ROM 206, the noise multiplication block 205 and the control block 107 shown in FIG. 2. In a preferable embodiment of the imaging system according to the invention of (2) adaptive to a color imaging device, the quantity of noise is worked out on the basis of information from the block signal extraction block 200, the color signal separation block 201, the average calculation block 202, the interval retrieval block 203, the noise interpolation block 204, ROM 206, the noise multiplication block 205 and the control block 107. In the invention of (2), the quantity of noise is calculated per ISO sensitivity and color signal adaptive to the color imaging device. The calculation of noise quantity per ISO sensitivity and color signal makes the precise estimation of noise quantity possible.

(3) In the invention of (1), said noise estimation means is characterized by comprising a calculation means for working out the quantity of noise per ISO sensitivity, based on a reference noise model and a correction coefficient accommodating to a white-and-black imaging device. The invention of (3) is embodied as the second, and the third embodiment shown in FIGS. 3-6, 8, 9, 11-13, and 15-16. The noise quantity calculation means adaptive to the white-and-black imaging device is equivalent to the block signal extraction block 2000, the average calculation block 2001, the interval retrieval block 2002, the noise interpolation block 2003, the ROM block 2005, the noise multiplication block 2004 and the control block 1007 shown in FIG. 4 illustrative of the second embodiment, and the block signal extraction block 2000, the average calculation block 2001, the interval retrieval block 6002, the noise interpolation block 6003, the ROM block 6005, the noise multiplication block 6004 and the control block 5007 shown in FIG. 6 illustrative of the third embodiment. In a preferable embodiment, used with a white-and-black imaging device, of the imaging system according to the invention of (3) corresponding to the second embodiment, the quantity of noise is worked out on the basis of information from the block signal extraction block 2000, the average calculation block 2001, the interval retrieval block 2002, the noise interpolation block 2003, the ROM block 2005, the noise multiplication block 2004 and the control block 1007. In a preferable embodiment, used with a white-and-black imaging device, of the imaging system according to the invention of (3) corresponding to the third embodiment, the quantity of noise is worked out on the basis of information from the block signal extraction block 2000, the average calculation block 2001, the interval retrieval block 6002, the noise interpolation block 6003, the ROM block 6005, the noise multiplication block 6004 and the control block 5007. In the invention of (3), the quantity of noise is calculated per ISO sensitivity adaptive to a white-and-black imaging device. The calculation of noise quantity per ISO sensitivity thus makes sure the precise estimation of noise quantity.

(4) In the invention of (1), said image processing means is characterized by comprising a noise reduction means for implementing noise reduction processing depending on the calculated quantity of noise. The invention of (4) is embodied as the first, the second, and the third embodiment shown in FIGS. 1-16. The noise reduction means is equivalent to the noise reduction block 105 of FIGS. 1 and 2, the noise reduction block 1005 of FIGS. 3 and 4, and the noise reduction block 1005 of FIGS. 5 and 6. In a preferable embodiment of the imaging system according to the invention of (4), filtering processing is implemented at the filtering block 300 of FIG. 7 in the first embodiment, the filtering block 3000 of FIG. 8 in the second embodiment, and the filtering block 3000 of FIG. 9 in the third embodiment. In the invention of (4), noise reduction processing is implemented by filtering processing. Thus, only noise components are removed so that the resulting signals are stored as original signals. High-definition images with only noise reduced are also obtained.

(5) In the invention of (1), said image processing means is characterized by comprising an edge enhancement means for applying edge enhancement to a signal with reduced noise. The invention of (5) is embodied as the second, and the third embodiment shown in FIGS. 3-6, 8, 9, 11-13, and 15-16. The edge enhancement means is equivalent to the edge enhancement block 1008 of FIGS. 3 and 5. In a preferable embodiment of the imaging system according to the invention of (5), edge extraction processing and edge enhancement processing are implemented at the filtering block 7002 and the edge control block 7003 of FIG. 15 in the second embodiment. In the invention of (5), the edge is enhanced by edge extraction processing and edge enhancement processing. This ensures that the edge portions are so enhanced that high-definition images are obtained.

(6) In the invention of (1), said noise estimation means is characterized by comprising a calculation means for working out the quantity of noise based on a single reference noise model and a plurality of transformation correction coefficients so as to accommodate to different imaging devices. The invention of (6) is embodied as the second embodiment shown in FIGS. 3, 4, 8, 11-13, and 15-16. The incorporation of a reference noise model and transformation correction coefficients adaptive to different imaging devices is equivalent to CCD 1002 and the imaging device recognition block 1011 of FIG. 5 and ROM 6005 of FIG. 6. In a preferable embodiment of the imaging system according to the invention of (6), the quantity of noise is calculated from the reference noise model and transformation correction coefficients adaptive to different imaging devices. Thus, the incorporation of the reference noise model and transformation correction coefficients adaptive to different imaging devices helps lessen loads on hardware while the precision of noise quantity calculation is secured.

(7) In the invention of (2), said correction coefficient is characterized by comprising a numerical parameter for working out the quantity of noise per other ISO sensitivity, and per other color signal, based on the reference noise model. The invention of (7) is embodied as the first embodiment shown in FIGS. 1, 2, 7, 10, and 12-14. The numerical parameter is equivalent to ROM 206 of FIG. 2. In a preferable embodiment of the imaging system according to the invention of (7), a correction coefficient for working out the quantity of noise per other ISO sensitivity and per other color signal is stored in ROM 206 of FIG. 2. In the invention of (7), the quantity of noise per other ISO sensitivity and per other color signal is worked out from the correction coefficient. Thus, as the quantity of noise per other ISO sensitivity and per other color signal is worked out from the correction coefficient, it helps lessen loads on hardware.

(8) In the invention of (2), said calculation means is characterized by comprising an extraction means for extracting a block signal, a separation means for separating said extracted signal per color filter, an average value calculation means for working out an average value of a signal value level per said separated color filter, a retrieval means for searching at which signal value level in the reference noise model in a function form said average value lies, a noise calculation means for implementing linear interpolation processing for an interval based on the reference noise model to work out the quantity of noise, and a calculation means for working out a quantity of noise in a desired noise model. The invention of (8) is embodied as the first embodiment shown in FIGS. 1, 2, 7, 10, and 12-14. The extraction means is equivalent to the block signal extraction block 200 of FIG. 2; the average calculation means is equivalent to the average calculation block 202 of FIG. 2; the retrieval means is equivalent to the internal retrieval block 203 of FIG. 2; the interpolation means is equivalent to the noise interpolation means 204 of FIG. 2; and the calculation means is equivalent to the noise multiplication means 205 of FIG. 2. A preferable embodiment of the invention of (8) is the imaging system of FIG. 2. This imaging system is designed such that a block signal is extracted at the block signal extraction block 200, a color signal is separated at the color signal separation block 201, an average value of a signal level is worked out at the average calculation block 202, at which signal level (coordinates) in a reference noise model in a function form the average value lies is searched at the interval retrieval block 203, a noise quantity is worked out at the noise interpolation block 204, and a noise quantity per color signal level at the desired ISO sensitivity is worked out at the noise multiplication block 205. With the invention of (8), the noise quantity is worked out through a process that involves the extraction of block signals, the separation of color signals, the calculation of average values, the retrieval of a signal level (coordinates) of the average value, noise interpolation, the multiplication of the result of noise interpolation by the correction coefficient and so on. Thus, as the noise quantity is worked out per color signal and per ISO sensitivity, it enables the precision of noise quantity estimation to grow high, and as the noise quantity is worked out based on the reference noise model, it helps lessen loads on hardware.

(9) In the invention of (3), said correction coefficient is characterized by comprising a numerical parameter for working out the quantity of noise per other ISO sensitivity, and per other color signal, based on the reference noise model. The invention of (9) is embodied as the second, and the third embodiment shown in FIGS. 3-6, 8, 9, 1-13, and 15-16. The numerical parameter is equivalent to the ROM block 2005 of FIG. 5, and the ROM block 6005 of FIG. 6. In a preferable embodiment of the imaging system according to the invention of (9), the correction coefficient for working out the quantity of noise per other ISO sensitivity is stored in the ROM block 2005 of FIG. 4 in the second embodiment, and the ROM block 6005 of FIG. 6 in the third embodiment. With the invention of (9), the noise quantity per other ISO sensitivity is worked out from the correction coefficient. Thus, as the noise quantity per other ISO sensitivity is worked out from the correction coefficient, it enables loads on hardware to be more lessened.

(10) In the invention of (3), said calculation means is characterized by comprising an extraction means for extracting a block signal, an average value calculation means for working out an average value of said extracted signal, a retrieval means for searching at which signal value level in the reference noise model in a function form said average value lies, a noise calculation means for implementing linear interpolation processing for an interval based on the reference noise model to work out the quantity of noise, and a calculation means for working out a quantity of noise in a desired noise model. The invention of (10) is embodied as the second, and the third embodiment shown in FIGS. 3-6, 8, 9, 11-13, and 15-16. The signal block extraction means is equivalent to the block signal extraction block 2000 of FIGS. 4 and 6; the calculation means is equivalent to the average calculation block 2001 of FIGS. 4 and 6; the retrieval means is equivalent to the interval retrieval block 2002 of FIG. 4 and the interval retrieval block 6002 of FIG. 6; the interpolation means is equivalent to the noise interpolation block 2003 of FIG. 4 and the noise interpolation block 6003 of FIG. 6; the calculation means for the desired noise quantity is equivalent to the noise multiplication block 2004 of FIG. 4 and the noise multiplication block 6004 of FIG. 6. In a preferable embodiment of the imaging system according to the invention of (10) corresponding to the second embodiment, block signals are extracted at the block signal extraction block 2000 of FIG. 4, the average value of signal levels is worked out at the average calculation block 2001, at which position (coordinates) in the reference noise model in a function form the average value lies is searched at the interval retrieval block 2002, the quantity of noise is worked out at the noise interpolation block 2003, and the quantity of noise is worked out per the desired ISO sensitivity at the noise multiplication block 2004. In a preferable embodiment of the imaging system according to the invention of (10) corresponding to the third embodiment, block signals are extracted at the block signal extraction block 2000 of FIG. 6, the average value of signal levels is worked out at the average calculation block 2001, at which signal level (coordinates) in the reference noise model in a function form the average value lies is searched at the interval retrieval block 6002, the quantity of noise is worked out at the noise interpolation block 6003, and the quantity of noise is worked out per the desired ISO sensitivity at the noise multiplication block 6004. With the invention of (10), the quantity of noise is worked out through a process involving the extraction of block signals from image signals, the calculation of the average value, the retrieval of the position (coordinates) of the average value, noise interpolation, the multiplication of the result of interpolation by the correction coefficient, and so on. Thus, the calculation of noise quantity per ISO sensitivity permits the precision of estimating noise quantity to grow high, and the calculation of noise quantity based on the reference noise model makes it possible to lessen loads on hardware.

(11) In the invention of (2) or (3), said reference noise model is characterized by comprising a numerical parameter wherein a quantity of noise with respect to a signal value level is in a function form. The invention of (11) is embodied as the first, the second, and the third embodiment shown in FIGS. 1-14. The numerical parameter is equivalent to ROM 206 of FIG. 2, ROM 2005 of FIG. 4, and ROM 6005 of FIG. 6. In a preferable embodiment of the imaging system according to the invention of (11), the function form of numerical parameter corresponding to the reference noise model is stored in the ROM block 2005 of FIG. 4 in the second embodiment, and in ROM 6005 of FIG. 6 in the third embodiment. In the invention of (11), the function form of numerical parameter of signal value level vs. noise quantity corresponding to the reference noise model is stored in hardware. Thus, the use of the reference noise model corresponding to the function form of numerical parameter makes it possible to provide a systematic and precise estimation of noise quantity.

(12) In the invention of (11), said numerical parameter is characterized by comprising coordinate data and slope data about a signal value level and a noise quantity at least two representative points. The invention of (12) is embodied as the first, the second, and the third embodiment shown in FIGS. 1-16. The coordinate data and slop data on the representative points are equivalent to ROM 206 of FIG. 2, the ROM block 2005 of FIG. 4, and ROM 6005 of FIG. 6. In a preferable embodiment of the imaging system according to the invention of (13), the reference noise model stored in the ROM block 206 of FIG. 2 in the first embodiment, ROM 2005 of FIG. 4 in the second embodiment, and ROM 6005 of FIG. 6 in the third embodiment is adaptive to the highest ISO sensitivity. Thus, the adaptability of the reference noise mode to the highest ISO sensitivity makes it possible to provide a high-precision estimation of noise quantity.

(13) In the invention of (2) or (3), said reference noise model is characterized by being adaptable to the highest ISO sensitivity. The invention of (13) is embodied as the first, the second, and the third embodiment shown in FIGS. 1-16. The reference noise model adaptable to the highest IOS sensitivity is equivalent to ROM 206 of FIG. 2, ROM 2005 of FIG. 4, and ROM 6005 of FIG. 6. In a preferable embodiment of the imaging system according to the invention of (13), the reference noise model stored in the ROM block 206 of FIG. 2 in the first embodiment, ROM 2005 of FIG. 4 in the second embodiment, and ROM 6005 of FIG. 6 in the third embodiment is adaptable to the highest ISO sensitivity. In the invention of (13), the reference noise model is adaptable to the highest ISO sensitivity. Thus, the adaptability of the reference noise model to the highest ISO sensitivity makes it possible to provide a high-precise estimation of noise quantity.

(14) In the invention of (2) or (3), said calculation means is characterized by comprising a plurality of reference noise models and a plurality of correction coefficients adaptable to different imaging devices. The invention of (14) is embodied as the third embodiment shown in FIGS. 3, 5, 9, 11-13, and 16. The incorporation of a plurality of reference noise model and a plurality of correction coefficient is equivalent to ROM 6005 of FIG. 6. In a preferable embodiment of the imaging system according to the invention of (14), there are plural reference noise models and plural correction coefficients provided so as to be adaptive to different imaging devices in which the adaptive reference noise model and correction coefficient are determined by ROM 6005 of FIG. 6. In the invention of (14), a plurality of reference noise models and a plurality of correction coefficients are provided in correspondence to different imaging devices. Thus, the provision of a plurality of reference noise models and a plurality of correction coefficients in correspondence to different imaging devices makes sure the precision of working out the quantity of noises in different imaging devices.

(15) The present invention also provides an image processing program for letting a computer implement steps, wherein said steps comprises a step of loading information about image pickup conditions, video signals, etc. in the computer, a step of extracting a pixel unit of given size around a pixel of interest, a step of reading a signal for each color signal, a step of finding out an average value of a designated signal level, a step of extracting a noise quantity correction coefficient and representative points of a noise quantity vs. signal level stored in a recording medium, a retrieval means for searching to which position in a reference noise model the average value belongs, a step of implementing interpolation of noise quantity by linear interpolation based on the reference noise model, a means for using the correction coefficient stored in the recording medium to work out a quantity of noise in a certain color signal at a certain ISO sensitivity, a step of implementing noise reduction processing by filtering, a step of storing a smoothened signal in a buffer, a step of judging whether operation of all color signals is over, and a step of judging whether processing of all pixels is over. The invention of (15) is equivalent to the flowchart of FIG. 14. With the invention of (15), noise reduction processing for color image signals can be implemented on software.

(16) Further, the present invention provides an image processing program for letting a computer implement steps, wherein said steps comprises a step of loading information about image pickup conditions, video signals, etc. in the computer, a step of extracting a pixel unit of given size around a pixel of interest, a step of reading a signal for each color signal, a step of finding out an average value of a designated signal level, a step of extracting a noise quantity correction coefficient and representative points of a noise quantity vs. signal level stored in a recording medium, a retrieval means for searching to which position in a reference noise model the average value belongs, a step of implementing interpolation of noise quantity by linear interpolation based on the reference noise model, a means for using the correction coefficient stored in the recording medium to work out a quantity of noise in a signal at a certain ISO sensitivity, a step of implementing noise reduction processing by filtering, a step of storing a smoothened signal in a buffer, and a step of judging whether processing of all pixels is over. The invention of (16) is equivalent to the flowchart of FIG. 16. With the invention of (16), noise reduction processing for white-and-black image signals can be implemented on software.

### BRIEF DESCRIPTION OF THE DRAWINGS

FIG. 1 is illustrative of the architecture of the first embodiment.

FIG. 2 is illustrative of the architecture of the noise estimation block in the first embodiment.

FIG. 3 is illustrative of the architecture of the second embodiment.

FIG. 4 is illustrative of the architecture of the noise estimation block in the second embodiment.

FIG. 5 is illustrative of the architecture of the third embodiment.

FIG. 6 is illustrative of the architecture of the noise estimation block in the third embodiment.

FIG. 7 is illustrative of the architecture of the noise reduction processing block in the first embodiment.

FIG. 8 is illustrative of the architecture of the noise reduction processing block in the second embodiment.

FIG. 9 is illustrative of the architecture of the noise reduction processing block in the third embodiment.

FIG. 10 is graphically representative of signal level vs. noise quantity relations.

FIG. 11 is graphically representative of signal level vs. noise quantity relations adapting to a plurality of imaging devices.

FIG. 12 is approximately representative of signal level vs. noise quantity relations in terms of a broken line.

FIG. 13 is graphically representative of interpolation processing for noise quantity.

FIG. 14 is a flowchart for the first embodiment.

FIG. 15 is illustrative of the architecture of the edge enhancement block in the second embodiment.

FIG. 16 is a flowchart for the second, and the third embodiment.

### BEST MODE FOR CARRYING OUT THE INVENTION

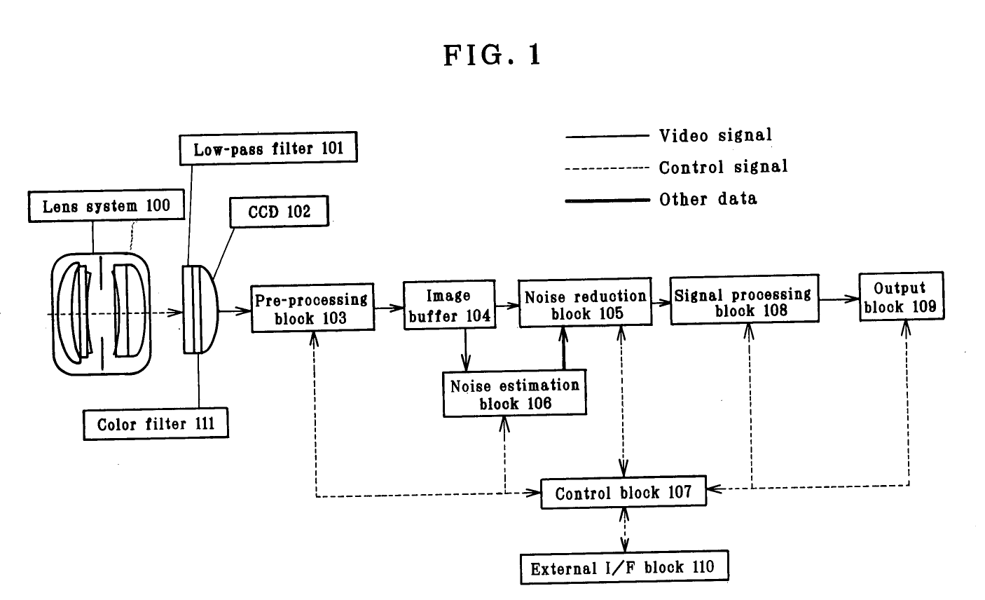

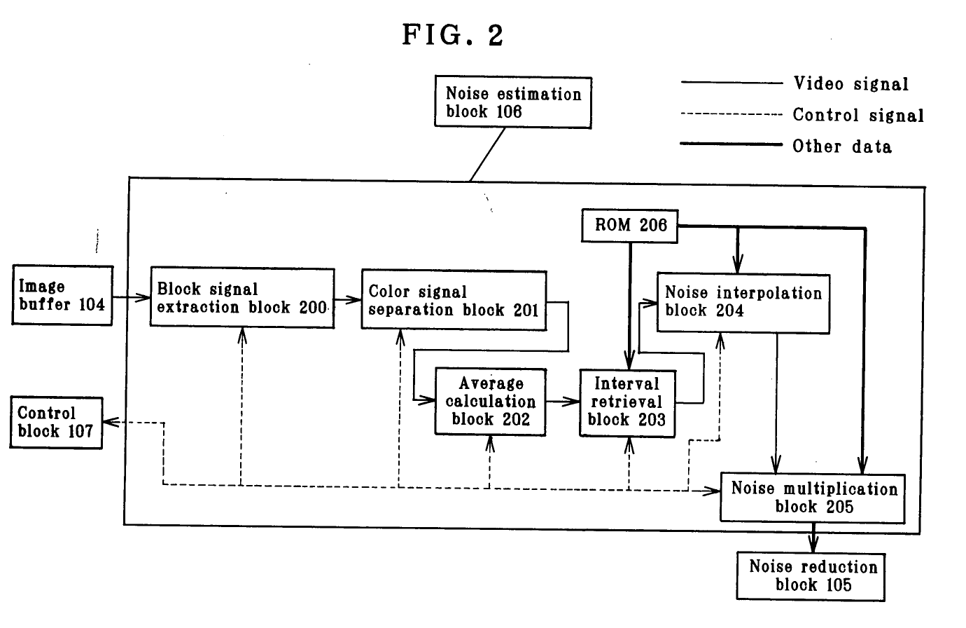

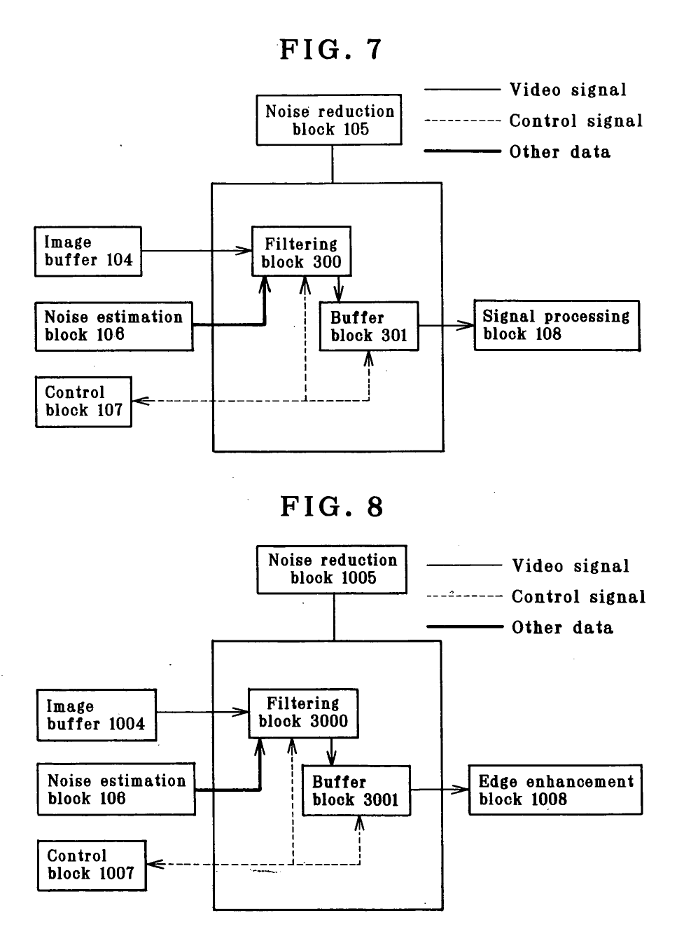

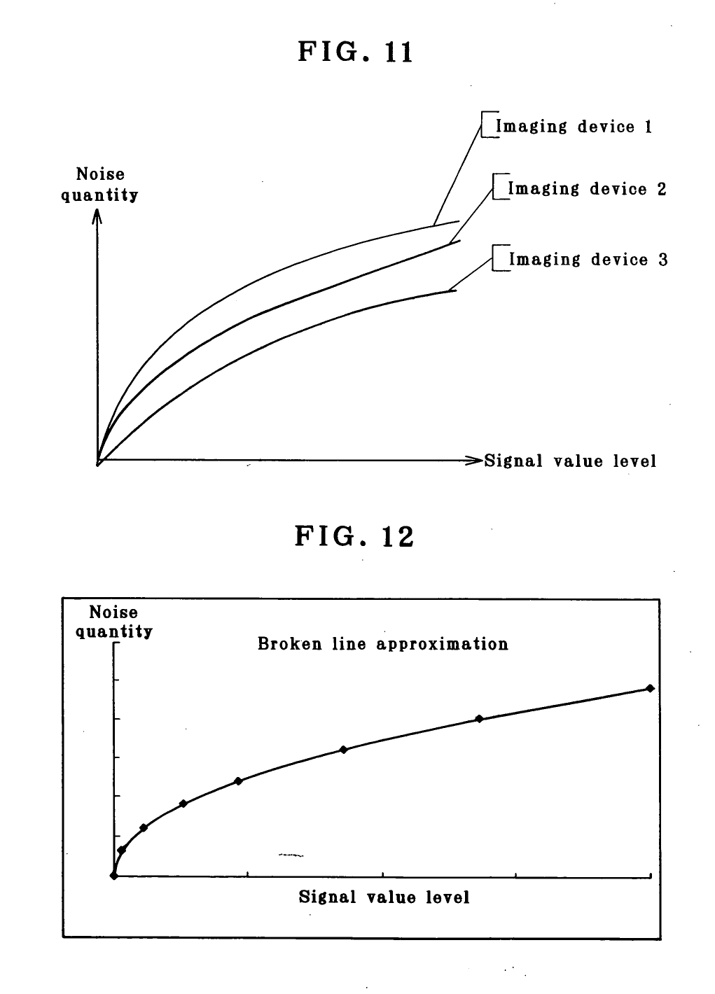

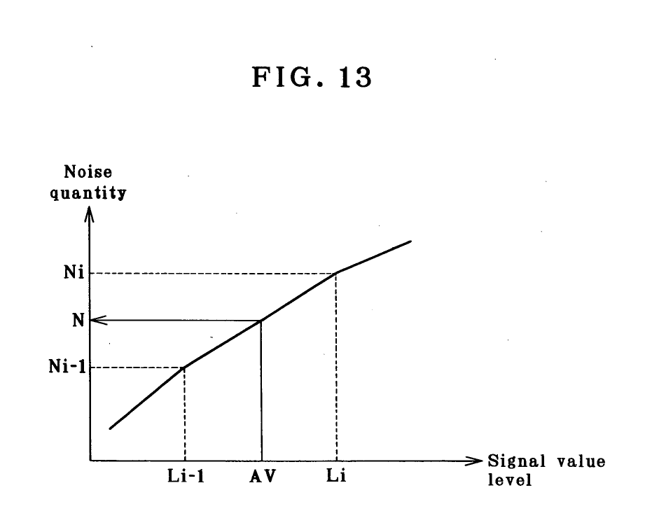

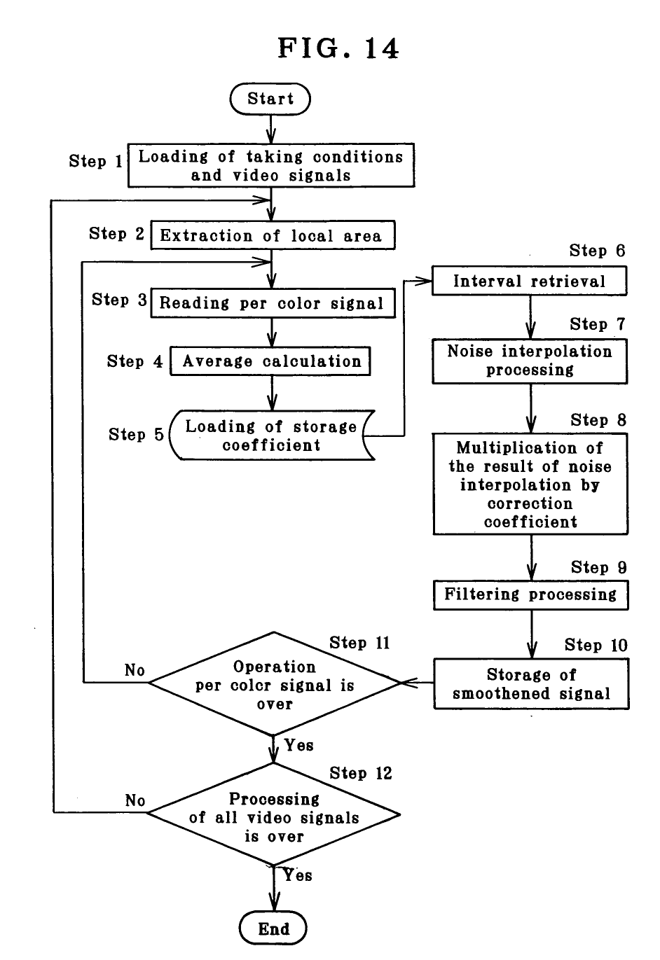

Several embodiments of the present invention are now explained with reference to the drawings. FIG. 1 is illustrative of the architecture of the first embodiment; FIG. 2 is illustrative of the architecture of the noise estimation block in the first embodiment; FIG. 7 is illustrative of the architecture of the noise reduction processing block in the first embodiment; FIG. 10 is graphically representative of signal level vs. noise quantity characteristics; FIG. 12 is approximately representative of signal level vs. noise quantity characteristics in terms of a broken line; FIG. 13 is a characteristic representation of interpolation processing for noise quantity; and FIG. 14 is a flowchart of noise reduction processing.

Referring to FIG. 1, an image taken by way of a lens system 100, a low-pass filter 101 and a CCD 102 having a color filter 111 is subjected to pre-processing such as sampling, gain amplification and A/D conversion at a pre-processing block 103, and thereafter forwarded to a noise reduction block 105 by way of an image buffer 104. Signals from the noise reduction block 105 are sent out to an output block 109 such as a memory card via a signal processing block 108. The image buffer 104 is connected to a noise estimation block 106 that is in turn connected to the noise reduction block 105. A control block 107 is bidirectionally connected to the pre-processing block 103, the noise estimation block 107, the noise reduction block 105, the signal processing block 108 and the output block 109. An external I/F block 110 comprising a power source switch, a shutter button and a taking mode select interface, too, is bidirectionally connected to the control block 107.

Referring further to FIG. 1, how signals flow is explained. After image pickup conditions such as ISO sensitivity are set by way of the external I/F block 110, the shutter is pressed down for image pickup. Video signals acquired via the lens system 100, the low-pass filter 101, the color filter 111 and the CCD 102 are forwarded to the pre-processing block 103, at which the video signals are sampled as mentioned above. The sampled video signals are further subjected to gain amplification, A/D converted, and forwarded to the image buffer 104. Video signals in the image buffer 104 are forwarded to the noise estimation block 106, to which taking conditions such as ISO sensitivity at the external I/F block are also forwarded by way of the control block 107. At the noise estimation block 106, on the basis of such taking conditions, the video signals and a reference noise model, the quantity of noise is worked out per ISO sensitivity, and per color signal. The calculated noise quantity is forwarded to the noise reduction block 105. The calculation of the noise quantity at the noise estimation block 106 takes place in sync with processing at the noise reduction block 105 under control at the control block 107. The noise reduction block 105 applies noise reduction processing to the video signals in the image buffer 104 based on the noise quantity estimated at the noise estimation block 106, forwarding video signals after noise reduction processing to the signal processing block 108. The signal processing block 108 applies known compression processing, enhancement processing, etc. to video signals after noise reduction processing under control at the control block 107, forwarding the video signals to the output block 109, at which the signals are recorded and stored in a recording medium such as a memory card.

FIG. 2 is illustrative of one example of the architecture of the noise estimation block 106. The noise estimation block 106 is made up of a block signal extraction block 200, a color signal separation block 201, an average calculation block 202, an interval retrieval block 203, a noise interpolation block 204, a noise multiplication block 205 and a ROM 206. The image buffer 104 is connected to the block signal extraction block 200. The control block 107 is bidirectionally connected to the block signal extraction block 200, the color signal separation block 201, the average calculation block 202, the interval retrieval block 203, the noise interpolation block 204 and the noise multiplication block 205. The block signal extraction block 200 is connected to the noise multiplication block 205 by way of the color signal separation block 201, the average calculation block 202, the interval retrieval block 203 and the noise interpolation block 204, and the ROM 206 is connected to the interval retrieval block 203, the noise interpolation block 204 and the noise multiplication block 205. The block signal extraction block 200 extracts block signals out of the video signals transmitted from the image buffer 104, forwarding them to the color signal separation block 201. The color signal separation block 201 separates the block signals transmitted from the block signal extraction block 200 for each color signal, forwarding them to the average calculation block 202. The average calculation block 202 works out an average value of the separated video signals transmitted from the color signal separation block 201 for each color signal, forwarding it to the interval retrieval block 203. The present invention comprises a reference noise model compatible with the noise characteristics of CCD 102.

FIG. 10 is graphically representative of signal value level vs. noise quantity correlations for the reference noise model, and FIG. 12 is approximately representative of signal value level vs. noise quantity correlations for the reference noise model in terms of a broken line. Representative points of the signal value level vs. noise quantity, representative of the reference noise model, are stored in ROM 206. Here, representative points of the signal value level (Level) vs. noise quantity (Noise) and points of slope (Slope) indicative of each representative point and the direction of an interval between representative points are stored in ROM 206. For instance, an example of 8 representative points and 7 points of slope are given by formulae (1)-(3).
Noise[8]={N1,N2,N3,N4,N5,N7,N8} (1)
Level[8]={L1,L2,L3,L4,L5,L6,L7,L8} (2)
Slope[7]={S1,S2,S3,S4,S5,S6,S7} (3)
In ROM 206, there is also a correction coefficient (K) recorded for the calculation of the quantity of noise per ISO sensitivity, and per color signal. For instance, an example of four ISO sensitivities and 4 color signals R, Gr, Gb and B is given by formula (4).
K[4][4]={Kr1,Kgr1,Kgb1,Kb1 ISO=100
Kr2,Kgr2,Kgb2,Kb2 ISO=200
Kr3,Kgr3,Kgb3,Kb3 ISO=300
Kr4,Kgr4,Kgb4,Kb4} ISO=400 (4)

In FIG. 2, the interval retrieval block 203 compares the average value transmitted from the average calculation block 202 with the signal value levels of the representative points stored in ROM 206 to search whether it belongs to between which signal value levels (coordinates). On the basis of the interval retrieval block 203, the noise interpolation block 204 implements linear interpolation within an interval to work out the quantity of noise with respect to the average value. FIG. 13 is illustrative of an example of linear interpolation processing of a certain interval by the noise interpolation block 204. The noise multiplication block 205 uses the result of interpolation from the noise interpolation block 204 and the correction coefficient stored in ROM 206 to work out, from formula (5), the quantity of noise (NR) for each color signal obtained at a certain ISO sensitivity from the control block 107.
NR=K[ISO][color]*N (5)
Note here that N is corresponding to N in FIG. 13. The result of the quantity of noise worked out is forwarded to the noise reduction block 105.

FIG. 7 is illustrative of one example of the architecture of the noise reduction block 105 that is made up of a filtering block 300 and a buffer block 301. The image buffer 104 is connected to the buffer block 301 via the filtering block 300, and the noise estimation block 106 is connected to the filtering block 300. The control block 107 is bidirectionally connected to the filtering block 300 and the buffer block 301. The buffer block 301 is connected to the signal processing block 108. The filtering block 300 uses the quantity of noise and the average value transmitted from the noise estimation block 106 to apply noise reduction processing to video signals at the image buffer 104.

For this noise reduction processing, the quantity of noise (NR) and the average value (Rav) are used to apply operation represented typically by formula (6) to a signal level (Rx) at a certain position.
If (Rx>Rav+NR/2)→Rx′=Rx−NR/2
If (Rav+NR/2>Rx>Rav−NR/2)→Rx′=Rx
If (Rx<Rav−NR/2)→Rx′=Rx+NR/2 (6)
A video signal Rx′ that has undergone noise reduction processing is stored in the buffer 301.

With the above arrangement, whatever imaging device is used, it is possible to estimate the quantity of noise depending on dynamically changing factors such as signal value levels, ISO sensitivities, and color signals. It is also possible to implement high-precision noise reduction processing, because that noise reduction processing is carried out on the basis of such estimation per ISO sensitivity, and per color signal. It is then possible to lessen loads on hardware by use of broken line or straight line approximation to the reference noise model and processing for deriving other model from the reference model. This embodiment of the present invention ensures that whatever color imaging device is used, it is possible to achieve both high-precision noise reduction processing and noise reduction processing for lessening loads on hardware.

There is one possible, preferable modification to this embodiment, wherein ROM 206 has a reference model for each of RGB components. This modified mode has the correction coefficient in ROM 206 at the ready depending on ISO sensitivity differences. At the noise multiplication block 205, the quantity of noise worked out from a different reference model for each color component is multiplied by the correction coefficient depending on the ISO sensitivity to work out the final quantity of noise. Even when the noise model for each color component cannot be approximated by a single reference model and correction coefficient combination, this model could make a higher-precision estimation of noise quantity.

The noise reduction processing here is achievable on hardware; however, similar processing may be run on software. FIG. 14 is a flowchart of noise reduction processing on software. At Step 1, information about image pickup conditions, video signals, etc. is read. At Step 2, a unit of given size, say, a 6×6 pixel unit is extracted around a pixel of interest. At Step 3, a signal is read out for each color signal, and at Step 4, an average value of a designated signal level is found out. At Step 5, the noise quantity correction coefficient and the representative points of the noise quantity vs. signal level, stored in the ROM, are extracted, and at Step 6, which position in the reference model they belong to is searched. At Step 7, linear interpolation of noise quantity is implemented on the basis of the reference noise model, and at Step 8, the correction coefficient stored in the ROM is used to work out the quantity of noise in a certain color signal at a certain ISO sensitivity. At Step 9, noise reduction processing is implemented by filtering. At Step 10, the smoothened signal is stored in the buffer. At Step 11, whether or not the operation of all color signals is over is judged, and if not, Step 3 is resumed, and if yes, Step 12 takes over. At step 12, whether or not the processing of all pixels is over is judged, and if not, Step 2 is then resumed, and if yes, it means that job has been done.

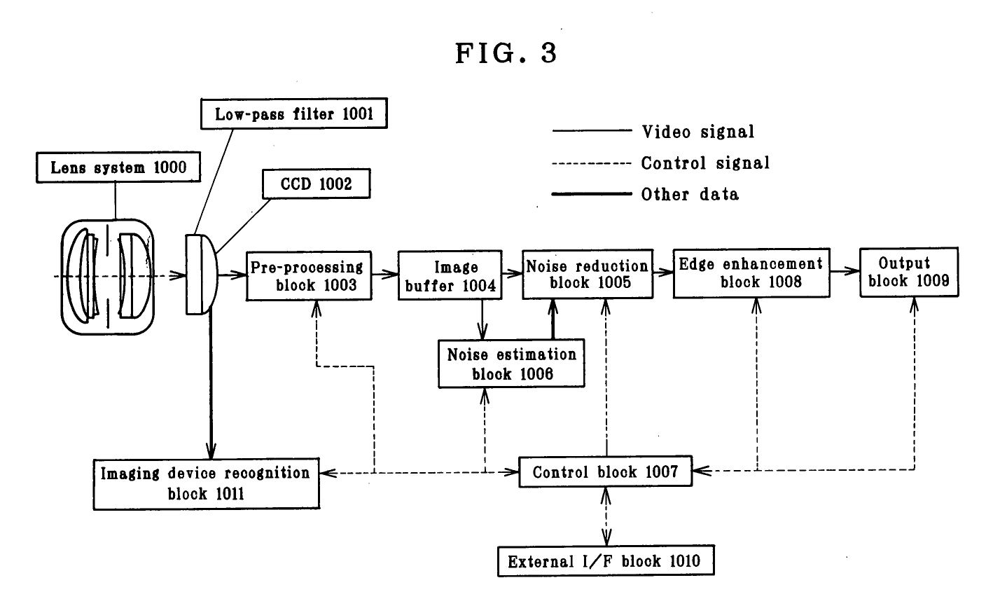

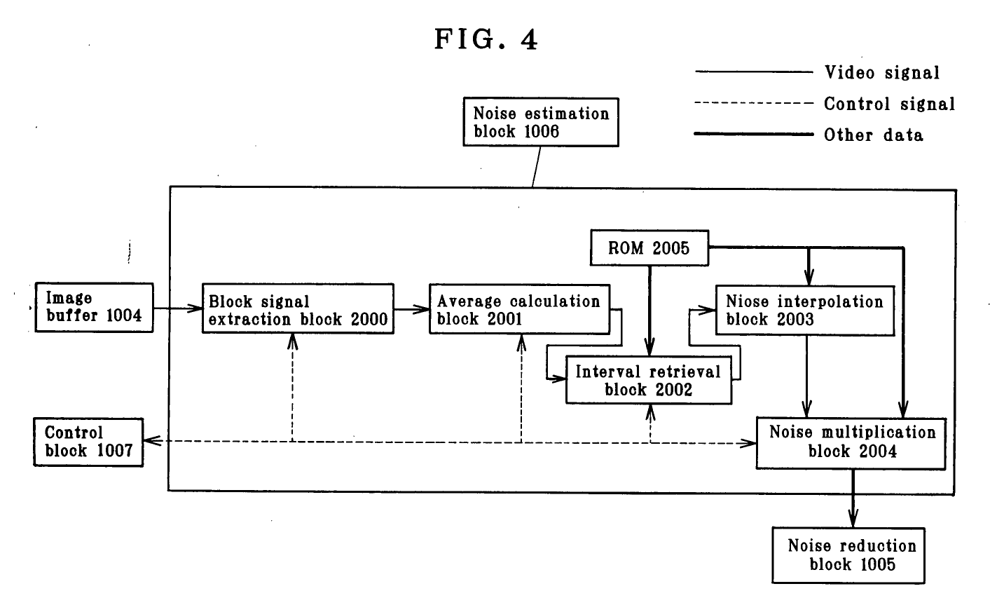

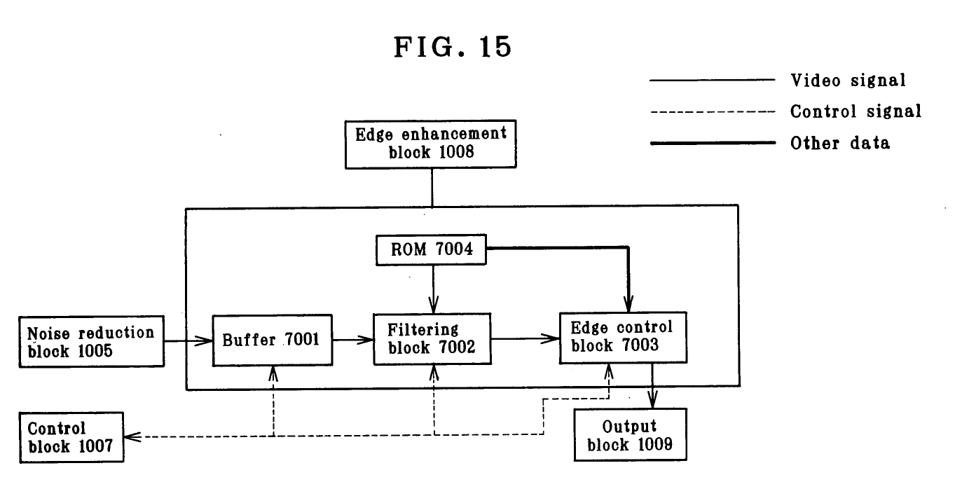

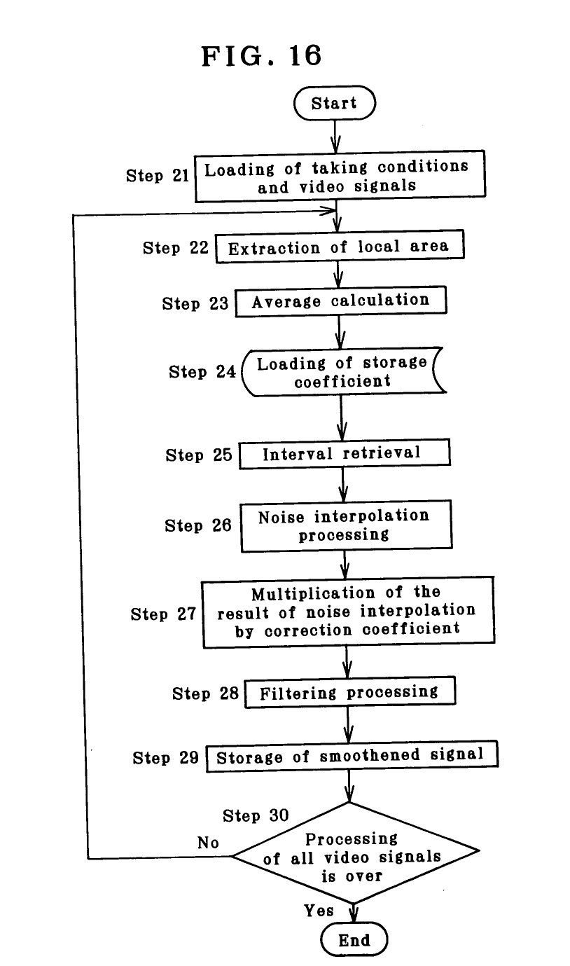

Next, the second embodiment of the present invention is explained. FIG. 3 is illustrative of the architecture of the second embodiment; FIG. 4 is illustrative of the architecture of the noise estimation block in the second embodiment; FIG. 11 is graphically indicative of signal level vs. noise quantity characteristics adapting to a plurality of imaging devices; FIG. 13 is a characteristic graph for noise quantity interpolation processing; FIG. 15 is illustrative of the edge enhancement block; and FIG. 16 is a flowchart of noise reduction processing.

Referring to FIG. 3, an image taken by way of a lens system 1000 and a white-and-black CCD 1002 having a low-pass filter 1001 is subjected to pre-processing such as sampling, gain amplification and A/D conversion at a pre-processing block 1003, and thereafter forwarded to a noise reduction block 1005 by way of an image buffer 1004. Signals from the noise reduction block 1005 are sent out to an output block 1009 such as a memory card via an edge enhancement block 1008. The image buffer 1004 is connected to a noise estimation block 1006 that is in turn connected to the noise reduction block 1005. An imaging device recognition block 1011 is connected to CCD 1002. A control block 1007 is bidirectionally connected to the pre-processing block 1003, the noise estimation block 1007, the noise reduction block 1005, the edge enhancement block 1008, the output block 1009 and the imaging device recognition block 1011. An external I/F block 1010 comprising a power source switch, a shutter button and a taking mode select interface, too, is bidirectionally connected to the control block 1007.

Referring further to FIG. 3, how signals flow is explained. After image pickup conditions such as ISO sensitivity are set by way of the external I/F block 1010, the shutter is pressed down for image pickup. Video signals acquired via the lens system 1000, the low-pass filter 1001 and the white-and-black CCD 1002 are forwarded to the pre-processing block 1003. The imaging device recognition block 1011 recognizes CCD 1002 to record in it the information in the imaging device. At the pre-processing block 1003, the transmitted video signals are sampled. The sampled video signals are further subjected to gain amplification, A/D converted, and forwarded to the image buffer 1004. Video signals in the image buffer 1004 are forwarded to the noise estimation block 1006, to which taking conditions such as ISO sensitivity at the external I/F block 1010 and the information in the imaging device at the imaging device recognition block 1011 are also forwarded by way of the control block 1007. At the noise estimation block 1006, on the basis of such taking conditions, the video signals and a reference noise model, the quantity of noise is worked out per ISO sensitivity. The calculated noise quantity is forwarded to the noise reduction block 1005.

The calculation of the noise quantity at the noise estimation block 1006 takes place in sync with processing at the noise reduction block 1005 under control at the control block 1007. The noise reduction block 1005 applies noise reduction processing to the video signals in the image buffer 1004 based on the noise quantity estimated at the noise estimation block 1006, forwarding video signals after the processing to the edge enhancement block 1008. The edge enhancement block 1008 applies edge enhancement to video signals after noise reduction processing under control at the control block 1007, forwarding the video signals to the output block 1009, at which the signals are recorded and stored in a recording medium such as a memory card.

FIG. 4 is illustrative of one example of the architecture of the noise estimation block 1006. The noise estimation block 1006 is made up of a block signal extraction block 2000, an average calculation block 2001, an interval retrieval block 2002, a noise interpolation block 2003, a noise multiplication block 2004 and a ROM 2005. The image buffer 1004 is connected to the block signal extraction block 2000. The control block 1007 is bidirectionally connected to the block signal extraction block 2000, the average calculation block 2001, the interval retrieval block 2002, the noise interpolation block 2003 and the noise multiplication block 2004. The block signal extraction block 2000 is connected to the noise multiplication block 2004 by way of the average calculation block 2001, the interval retrieval block 2002 and the noise interpolation block 2003, and ROM 2005 is connected to the interval retrieval block 2002, the noise interpolation block 2003 and the noise multiplication block 2004. The block signal extraction block 2000 extracts block signals out of the video signals transmitted from the image buffer 1004, forwarding them to the average calculation block 2001. The average calculation block 2001 works out an average value of the video signals transmitted from the block signal extraction block 2000, forwarding it to the interval retrieval block 2002.

In the embodiment here, there is one reference noise model as in the first embodiment, but there are correction coefficients to keep up with different imaging devices. And then, the type of the imaging device CCD 1002 used is detected by the imaging device recognition block 1011 of FIG. 3 to extract out of correction coefficients (M) in ROM 2005 of FIG. 4 the one corresponding to that imaging device by way of the control block 1007. For instance, an example of correction coefficients corresponding to three different imaging devices is represented by formula (7).
M[3]={M1, Imaging Device 1
M2, Imaging Device 2
M3} Imaging Device 3 (7)

For the reference noise model, data approximated to a broken line are stored in ROM 2005, as in the first embodiment. A specific data form comprises 8 representative points of the signal value level vs. noise quantity and 7 points of slope indicative of each representative point and a direction of an interval between representative points. The interval retrieval block 2002 compares the average value transmitted from the average calculation block 2001 with the signal value levels of the representative points stored in ROM 2005 to search to which signal level value it belongs (coordinates). On the basis of the result of retrieval at the interval retrieval block 2002, the noise interpolation block 2003 implements linear interpolation within the interval, thereby working out the quantity of noise with respect to the average value.

FIG. 13 is illustrative of how linear interpolation processing takes place in a certain interval. In ROM 2005, there is also a correction coefficient for calculating the quantity of noise per ISO sensitivity recorded. For instance, an example of correction coefficients corresponding to four different ISO sensitivities is represented by formula (8).
K[4]={K1, ISO=100
K2, ISO=200
K3, ISO=300
K4} ISO=400 (8)

The noise multiplication block 2004 uses the result of interpolation from the noise interpolation block 2003, the correction coefficient corresponding to CCD 1002 and the correction coefficient corresponding to each ISO sensitivity, both coefficients stored in ROM 2005, to work out, from formula (9), the quantity of noise (NR) for each signal obtained at a certain ISO sensitivity from the control block 1007.
NR=K[Imaging Device]*K[ISO]*N (9)
Note here that N is corresponding to N in FIG. 13. The result of the quantity of noise worked out is forwarded to the noise reduction block 1005.

FIG. 8 is illustrative of one example of the architecture of the noise reduction block 1005 that is made up of a filtering block 3000 and a buffer block 3001. The image buffer 1004 is connected to the buffer block 3001 via the filtering block 3000, and the noise estimation block 1006 is connected to the filtering block 3000. The control block 1007 is bidirectionally connected to the filtering block 3000 and the buffer block 3001. The buffer block 3001 is connected to the edge enhancement block 1008. The filtering block 3000 uses the quantity of noise and the average value transmitted from the noise estimation block 1006 for noise reduction processing. For this noise reduction processing, the quantity of noise (NR) and the average value (Rav) are used to apply operation represented by formula (10) to a signal level (Rx) at a certain position.
If (Rx>Rav+NR/2)→Rx′=Rx−NR/2
If (Rav+NR/2>Rx>Rav−NR/2)−Rx′=Rx
If (Rx<Rav−Nr/2)→Rx′=Rx+NR/2 (10)
A video signal Rx′ that has undergone noise reduction processing is stored in the buffer 3001.

FIG. 15 is illustrative of one example of the architecture of the edge enhancement block 1008 that is built up of a buffer 7001, a filter block 7002, an edge control block 7003 and a ROM block 7004. The noise reduction block 1005 is connected to the output block 1009 via the buffer 7001, the filtering block 7002 and the edge control block 7003, and ROM 7004 is connected to the filtering block 7002 and the edge control block 7003. The control block 1007 is bidirectionally connected to the buffer 7001, the filtering block 7002 and the edge control block 7003. Under control at the control block 1007, the filtering block 7002 reads the filter coefficient necessary for edge extraction processing out of ROM 7004 to apply known edge extraction processing to video signals at the buffer 7001. Under control at the control block 1007, the edge control block 7003 uses video signals transmitted from the filtering block 7002 to read an edge enhancement filter coefficient out of ROM 7004 to apply known edge enhancement processing to the edge portions of the video signals.

With the above arrangement, whatever white-and-black imaging devices having a variety of different noise characteristics are used, it is possible to estimate the quantity of noise depending on dynamically changing factors such as signal value levels and ISO sensitivities. It is also possible to implement high-precision noise reduction processing, because that noise reduction processing is carried out on the basis of such estimation per imaging device, and per ISO sensitivity. It is then possible to lessen loads on hardware by use of broken line or straight line approximation to the reference noise model and processing for deriving other model from the reference model. This embodiment of the present invention thus ensures that whatever white-and-black imaging device is used, it is possible to achieve both high-precision noise reduction processing and processing for lessening loads on hardware.

The noise reduction processing here is achievable on hardware; however, similar processing may be run on software. FIG. 16 is a flowchart of noise reduction processing on software. At Step 21, information about image pickup conditions, video signals, etc. is read. At Step 22, a unit of given size, say, a 6×6 pixel unit is extracted around a pixel of interest. At Step 23, an average value of a designated signal level is found out. At Step 24, the noise quantity correction coefficient and the representative points of the noise quantity vs. signal level, stored in the ROM, are extracted, and at Step 25, which position in the reference model they belong to is searched. At Step 26, linear interpolation of noise quantity is implemented on the basis of the reference noise model, and at Step 27, the correction coefficient stored in the ROM is used to work out the quantity of noise in a color signal at a certain ISO sensitivity. At Step 28, noise reduction processing is implemented by filtering. At Step 29, the smoothened signal is stored in the buffer. At Step 30, whether or not the processing of all pixels is over is judged, and if not, Step 22 is then resumed, and if yes, it means that job has been done.

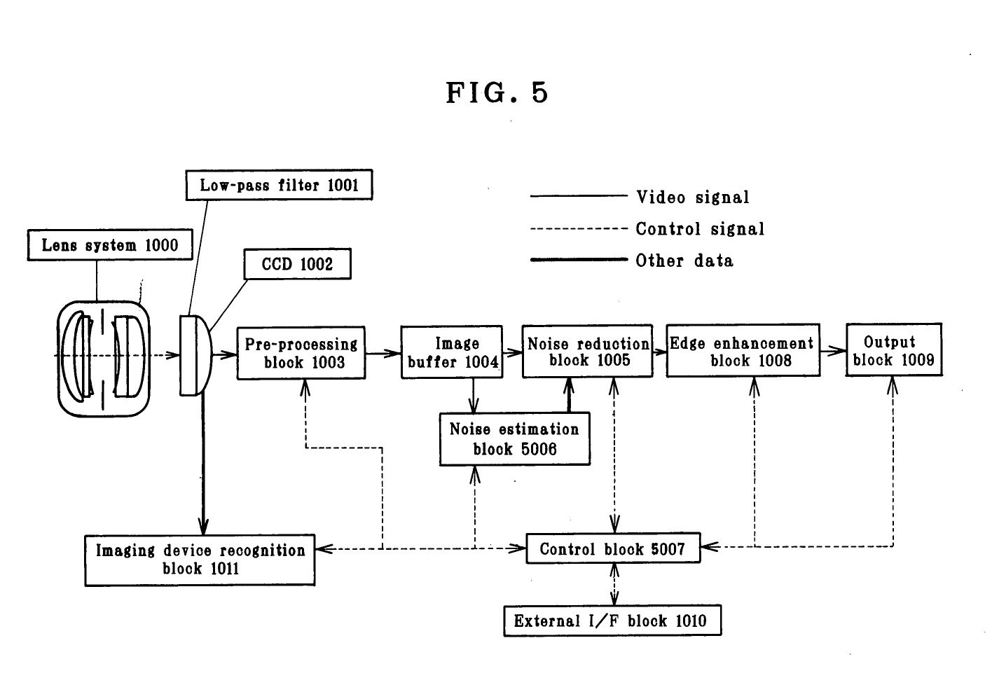

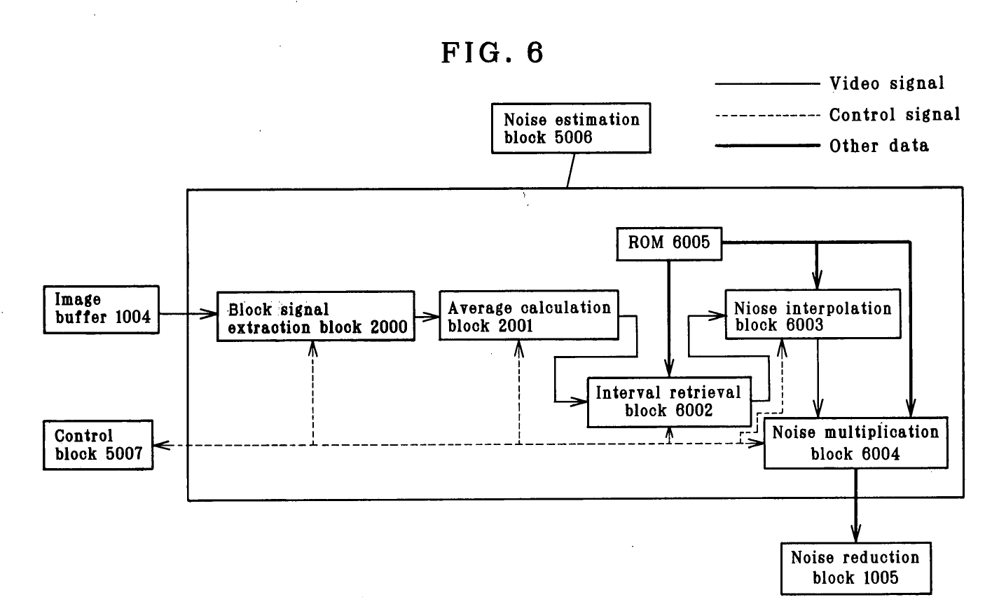

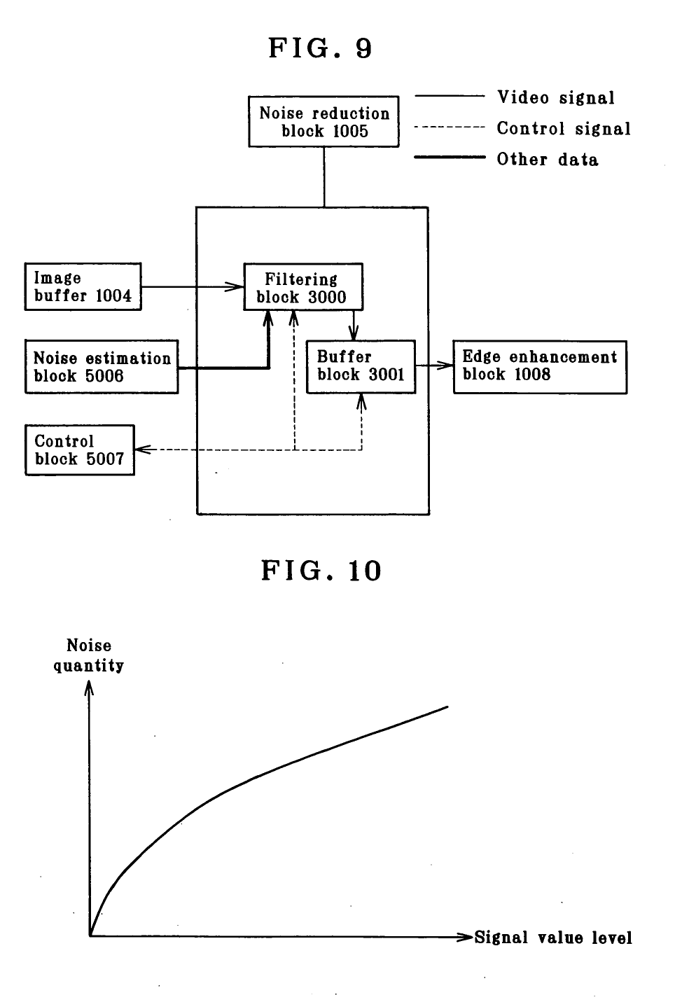

Next, the third embodiment of the present invention is explained. FIG. 5 is illustrative of the architecture of the third embodiment; FIG. 6 is illustrative of the architecture of the noise estimation block in the third embodiment; and FIG. 9 is illustrative of the noise reduction processing block in the third embodiment. The third embodiment has the same arrangement and requirement as in the second embodiment except for a noise estimation block 5006 and a control block 5007. Therefore, how signals flow in the noise estimation block 5006 and the control block 5007 is explained. In the following, what is indicated by the same numerals as in the second embodiment works or operates as in the second embodiment.

FIG. 5 is illustrative of the embodiment here. An image taken by way of the lens system 1000 and the white-and-black CCD 1002 having a low-pass filter 1001 is sampled at the pre-processing block 1003. After subjected to pre-processing such as gain amplification and A/D conversion, the sampled signal is forwarded to the noise reduction block 1005 by way of the image buffer 1004. Signals from the noise reduction block 1005 are sent out to the output block 1009 such as a memory card via the edge enhancement block 1008. The image buffer 1004 is connected to the noise estimation block 5006 that is in turn connected to the noise reduction block 1005. The imaging device recognition block 1011 is connected to CCD 1002. The control block 5007 is bidirectionally connected to the pre-processing block 1003, the noise estimation block 5006, the noise reduction block 1005, the edge enhancement block 1008, the output block 1009 and the imaging device recognition block 1011. The external I/F block 1010 comprising a power source switch, a shutter button and a taking mode select interface, too, is bidirectionally connected to the control block 5007.

In the embodiment here, too, there is noise reduction achievable with various imaging devices, as in the second embodiment. However, a difference with the second embodiment is that, as shown in FIG. 11, ROM 6005 has a plurality of reference noise models corresponding to different imaging devices at the ready. And then, the type of the imaging device CCD 1002 used is detected by the imaging device recognition block 1011 of FIG. 5, and the reference noise model corresponding to CCD 112 is extracted from ROM 6005 of FIG. 6 by way of the control block 5007. The data form for the noise model is the same as shown in formulae (1), (2) and (3). An interval retrieval block 6002 compares the average value transmitted from the average calculation block 2001 with the signal value levels of the representative points of the noise model extracted at the control block 5007 to search to which signal level value it belongs. On the basis of the result of retrieval at the interval retrieval block 6002, a noise interpolation block 6003 implements linear interpolation within the interval, thereby working out the quantity of noise with respect to the average value. To this linear interpolation, the linear interpolation processing in a certain interval shown in FIG. 13 is applied.

A noise multiplication block 6004 uses the result of interpolation from the noise interpolation block 6003 and the correction coefficient per ISO sensitivity corresponding to the reference noise model corresponding to CCD 1002, stored in ROM 6005, to work out, from formula (11), the quantity of noise (NR) for each signal obtained at a certain ISO sensitivity from the control block 5007.
NR=K[Imaging Device][ISO]*N (11)
Note here that N is corresponding to N in FIG. 13. And then, the result of the quantity of noise worked out is forwarded to the noise reduction block 1005.

FIG. 9 is illustrative of one example of the architecture of the noise reduction block 1005 that is made up of a filtering block 3000 and a buffer block 3001. The image buffer 1004 is connected to the buffer block 3001 via the filtering block 3000, and the noise estimation block 5006 is connected to the filtering block 3000. The control block 5007 is bidirectionally connected to the filtering block 3000 and the buffer block 3001. The buffer block 3001 is connected to the edge enhancement block 1008. The filtering block 3000 uses the quantity of noise and the average value transmitted from the noise estimation block 1006 to apply noise reduction processing to video signals at the image buffer 1004. The noise reduction processing and the edge enhancement processing are the same as in the second embodiment.

With the above arrangement, whatever white-and-black imaging devices having a variety of different noise characteristics are used, it is possible to estimate the quantity of noise depending on dynamically changing factors such as signal value levels and ISO sensitivities. It is also possible to implement high-precision noise reduction processing, because that noise reduction processing is carried out on the basis of such estimation per imaging device, and per ISO sensitivity. It is then possible to lessen loads on hardware by use of broken line or straight line approximation to the reference noise model and processing for deriving other model from the reference model. This embodiment of the present invention thus ensures that whatever white-and-black imaging device is used, it is possible to achieve both high-precision noise reduction processing and processing for lessening loads on hardware.

The image processing program for color images shown in FIG. 14, and the image processing program for white-and-black images shown in FIG. 16 may be recorded in a recording medium. If this recording medium is installed in a computer, it is then possible to apply high-precision noise reduction processing to color images, and white-and-black image without place and time constraints in applications where the computer can run.

### POSSIBLE INDUSTRIAL APPLICATIONS

According to the present invention as expounded above, it is possible to provide an imaging system that uses a noise quantity model well adapting to not only signal levels but also dynamically changing factors correlating to random noise such as signal value levels, ISO sensitivities and color signals to make a precise estimation of noise quantity. It is also possible to provide an image program capable of making an accurate estimation of the quantity of noise in image signals.

1. An imaging system adapted to process a digitalized signal from an imaging device, comprising a noise estimation means for estimating a quantity of noise in said signal; and an image processing means for implementing image processing based on said quantity of noise.

2. The imaging system according to claim 1, wherein said noise estimation means comprises a calculation means for working out the quantity of noise per ISO sensitivity, and per color signal, based on at least one or more reference noise models and correction coefficients corresponding to a color imaging device.

3. The imaging system according to claim 1, wherein said noise estimation means comprises a calculation means for working out the quantity of noise per ISO sensitivity, based on a reference noise model and a correction coefficient corresponding to a white-and-black imaging device.

4. The imaging system according to claim 1, wherein said image processing means comprises a noise reduction means for implementing noise reduction processing depending on the calculated quantity of noise.

5. The imaging system according to claim 1, wherein said image processing means comprises an edge enhancement means for applying edge enhancement to a signal with reduced noise.

6. The imaging system according to claim 1, wherein said noise estimation means comprises a calculation means for working out the quantity of noise based on a single reference noise model and a plurality of transformation correction coefficients so as to be adaptive to different imaging devices.

7. The imaging system according to claim 2, wherein said correction coefficient comprises a numerical parameter for working out the quantity of noise per other ISO sensitivity, and per other color signal, based on the reference noise model.

8. The imaging system according to claim 2, wherein said calculation means comprises an extraction means for extracting a block signal, a separation means for separating said extracted signal per color filter, an average value calculation means for working out an average value of a signal value level per said separated color filter, a retrieval means for searching at which signal value level in the reference noise model in a function form said average value lies, a noise calculation means for implementing linear interpolation processing for an interval based on the reference noise model to work out the quantity of noise, and a calculation means for working out a quantity of noise in a desired noise model.

9. The imaging system according to claim 3, wherein said correction coefficient comprises a numerical parameter for working out the quantity of noise per other ISO sensitivity, and per other color signal, based on the reference noise model.

10. The imaging system according to claim 3, wherein said calculation means comprises an extraction means for extracting a block signal, an average value calculation means for working out an average value of said extracted signal, a retrieval means for searching at which signal value level in the reference noise model in a function form said average value lies, a noise calculation means for implementing linear interpolation processing for an interval based on the reference noise model to work out the quantity of noise, and a calculation means for working out a quantity of noise in a desired noise model.

11. The imaging system according to claim 2, wherein said reference noise model comprises a numerical parameter wherein a quantity of noise with respect to a signal value level is in a function form.

12. The imaging system according to claim 11, wherein said numerical parameter comprises coordinate data and slope data about a signal value level and a noise quantity at least two representative points.

13. The imaging system according to claim 2, wherein said reference noise model is adaptive to the highest ISO sensitivity.

14. The imaging system according to claim 2, wherein said calculation means comprises a plurality of reference noise models and a plurality of correction coefficients corresponding to different imaging devices.

15. An image processing program for letting a computer implement steps, wherein said steps comprises a step of loading information about image pickup conditions, video signals, etc. in the computer, a step of extracting a pixel unit of given size around a pixel of interest, a step of reading a signal for each color signal, a step of finding out an average value of a designated signal level, a step of extracting a noise quantity correction coefficient and representative points of a noise quantity vs. signal level stored in a recording medium, a retrieval means for searching to which position in a reference noise model the average value belongs, a step of implementing interpolation of noise quantity by linear interpolation based on the reference noise model, a means for using the correction coefficient stored in the recording medium to workout a quantity of noise in a certain color signal at a certain ISO sensitivity, a step of implementing noise reduction processing by filtering, a step of storing a smoothened signal in a buffer, a step of judging whether operation of all color signals is over, and a step of judging whether processing of all pixels is over.

16. An image processing program for letting a computer implement steps, wherein said steps comprises a step of loading information about image pickup conditions, video signals, etc. in the computer, a step of extracting a pixel unit of given size around a pixel of interest, a step of reading a signal for each color signal, a step of finding out an average value of a designated signal level, a step of extracting a noise quantity correction coefficient and representative points of a noise quantity vs. signal level stored in a recording medium, a retrieval means for searching to which position in a reference noise model the average value belongs, a step of implementing interpolation of noise quantity by linear interpolation based on the reference noise model, a means for using the correction coefficient stored in the recording medium to work out a quantity of noise in a signal at a certain ISO sensitivity, a step of implementing noise reduction processing by filtering, a step of storing a smoothened signal in a buffer, and a step of judging whether processing of all pixels is over.

17. The imaging system according to claim 3, wherein said reference noise model comprises a numerical parameter wherein a quantity of noise with respect to a signal value level is in a function form.

18. The imaging system according to claim 17, wherein said numerical parameter comprises coordinate data and slope data about a signal value level and a noise quantity at least two representative points.

19. The imaging system according to claim 3, wherein said reference noise model is adaptive to the highest ISO sensitivity.

20. The imaging system according to claim 3, wherein said calculation means comprises a plurality of reference noise models and a plurality of correction coefficients corresponding to different imaging devices.
